(19) United States
(12) Patent Application Publication
(10) Pub. No.: US 2019/0384057 A1
(43) Pub. Date: Dec. 19, 2019

(54) VIEW ANGLE CONTROL SHEET AND METHOD OF PRODUCING VIEW ANGLE CONTROL SHEET

(71) Applicant: SHARP KABUSHIKI KAISHA, Osaka (JP)

(72) Inventors: KOTA MORI, Osaka (JP); NOBUYUKI TAKAHASHI, Osaka (JP)

(21) Appl. No.: 16/436,326

(22) Filed: Jun. 10, 2019

Related U.S. Application Data
(60) Provisional application No. 62/684,587, filed on Jun. 13, 2018.

(51) Int. Cl. G02B 27/00; G02B 27/01; B60K 35/00; B60K 37/02

(52) U.S. Cl. CPC G02B 27/0081; G02B 27/0101; B60K 2370/52; B60K 37/02; B60K 2370/1529; B60K 35/00

(57) ABSTRACT

A viewing angle control sheet located on a light output side of a display device having a display surface curving in accordance with distance from the sloping reflective member, the viewing angle control sheet being curved along the display surface to control a viewing angle of an image displayed on the display surface, the viewing angle control sheet includes light-transmitting portions and light-blocking portions alternately arranged in a curving direction of the display surface, and the light viewing angle control sheet is configured such that θ1 satisfies the following expression (1),

$$\begin{matrix}[ expr . 1 ] & \\ θ 1 ≦ {cos}^{- 1} ( \frac{f - df \cdot cos θ 2}{\sqrt{{f}^{2} + {df}^{2} - 2 \cdot f \cdot df \cdot cos θ 2}} ) + θ 2 & ( 1 )\end{matrix}$$

in which “f” is a length of the sloping reflective member, “df” is a distance between a slope origin of the sloping reflective member and a light-output-side end of the light-blocking portions, “θ1” is a maximum elevation angle of light passing through the light-transmitting portions, and “θ2” is an elevation angle of the sloping reflective member.

### CROSS REFERENCE TO RELATED APPLICATION

This application claims priority from U.S. Provisional Application No. 62/684,587 filed on Jun. 13, 2018. The entire contents of the priority application are incorporated herein by reference.

### TECHNICAL FIELD

The present technology relates to a viewing angle control sheet and a method of producing a viewing angle control sheet.

### BACKGROUND

One example of a known viewing angle control sheet (light control sheet), which controls a viewing angle of an image displayed on a display surface of a display device, is described in Patent Document 1 listed below. The light control sheet described in Patent Document 1 is obtained by grinding a smooth transparent surface of a sheet with a dicing saw such that the sheet has parallel grooves having frosted glass-like opaque rough inner surfaces.

### RELATED ART DOCUMENT

[Patent Literature 1] Japanese Unexamined Patent Application Publication No. H9-311206

The light control sheet described in Patent Document 1 is designed for a display device having a flat display surface. However, some recent in-vehicle display devices have curved display surfaces. In such cases, the light control sheet also needs to be curved along the display surface. However, the viewing angle would not be properly controlled by the curved light control sheet, allowing the image on the display surface to be reflected on the front glass.

### SUMMARY

The present technology was made in view of the above-described circumstance and an object of the present technology is to prevent the reflection.

An embodiment according to the present technology is a viewing angle control sheet located inwardly of a sloping reflective member that tilts forward and reflects light and located on a light output side of a display device having a display surface curving in accordance with distance from the sloping reflective member. The viewing angle control sheet is curved along the display surface so as to control a viewing angle of an image displayed on the display surface. The viewing angle control sheet includes light-transmitting portions, which transmit light, and light-blocking portions, which block light, alternately arranged in a curving direction of the display surface. The light viewing angle control sheet is configured such that θ1 satisfies the following expression (1), in which “f” is a length of the sloping reflective member, “df” is a distance between a slope origin of the sloping reflective member and a light-output-side end of the light-blocking portions, “θ1” is a maximum elevation angle of light passing through the light-transmitting portions, and “θ2” is an elevation angle of the sloping reflective member.

$$\begin{matrix}[ expr . 1 ] & \\ θ 1 ≦ {cos}^{- 1} ( \frac{f - df \cdot cos θ 2}{\sqrt{{f}^{2} + {df}^{2} - 2 \cdot f \cdot df \cdot cos θ 2}} ) + θ 2 & ( 1 )\end{matrix}$$

In this configuration, an image is displayed by using outgoing light from the display surface of the display device, and the output angle of the outgoing light is controlled by the viewing angle control sheet located on the light-output side of the display device. Specifically described, in the viewing angle control sheet including the light-transmitting portions and the light-blocking portions alternately arranged in the curving direction of the display surface, the output angle of light passing through the light-transmitting portions is controlled by the light-blocking portions adjacent to the light-transmitting portions. Here, the display device is located inwardly of the sloping reflective member, which tilts forward and reflects light. A viewing angle control sheet designed to be used in a flat state may be curved and used as the viewing angle control sheet curved along the display surface, which curves in accordance with distance from the sloping reflective member. However, in such a case, the output angle of light passing through the light-transmitting portions is not properly controlled and some of the output light may reach and reflect off the sloping reflective member, resulting in that the image on the display surface is reflected on the sloping reflective member. To solve the problem, the viewing angle control sheet is configured such that the maximum elevation angle θ1 of light passing through the light-transmitting portions satisfies the above expression (1). This does not allow the light passing through the light-transmitting portions to reach the sloping reflective member. Thus, the image on the display surface is not reflected on the sloping reflective member. In particular, this is advantageous for a display surface and a viewing angle control sheet that have a complex curve.

The present technology does not allow reflection.

### BRIEF DESCRIPTION OF THE DRAWINGS

FIG. 1 is a schematic side view illustrating a liquid crystal display device and a viewing angle control sheet according to a first embodiment of the present technology, which are mounted in a car.

FIG. 2 is a view illustrating a triangle having a slope origin and a slope end of a front glass and a light-output-side end of a light-blocking portion as vertices.

FIG. 3 is a side view illustrating a viewing angle control sheet according to a comparative example in a comparative experiment before being curved.

FIG. 4 is a side view illustrating the viewing angle control sheet according to the comparative example in the comparative experiment after being curved.

FIG. 5 is a graph indicating a brightness angle distribution according to the comparative example in the comparative experiment.

FIG. 6 is a graph indicating a brightness angle distribution according to an example in the comparative example.

FIG. 7 is a schematic side view illustrating a viewing angle control sheet according to a second embodiment of the present technology, which is mounted in a car.

FIG. 8 is a schematic cross-sectional view illustrating an extruder used in a sheet formation process in a method of producing the viewing angle control sheet.

FIG. 9 is a perspective view illustrating a continuous light-transmitting portion produced by the extruder.

FIG. 10 is a cross-sectional view illustrating the continuous light-transmitting portion produced by the extruder.

FIG. 11 is a cross-sectional view illustrating the continuous light-transmitting portion having the spaces filled with a light-blocking material.

FIG. 12 is a cross-sectional view illustrating the continuous light-transmitting portion from which a retainer was removed.

FIG. 13 is a cross-sectional view illustrating a flat viewing angle control sheet including a sheet support.

FIG. 14 is a side view illustrating a viewing angle control sheet before being curved.

FIG. 15 is a side view illustrating the viewing angle control sheet after being curved.

FIG. 16 is a view illustrating a triangle having an intersection of a first imaginary line and a second imaginary line, the slope origin of a front glass, and the light-output-side end of the light-blocking portion as vertices, for example, according to a third embodiment of the present technology.

FIG. 17 is a view illustrating a triangle having an intersection of the first imaginary line and the second imaginary line, the slope end of the front glass, and the light-output-side end of the light-blocking portion as vertices.

FIG. 18 is a view illustrating a triangle having an intersection of the first imaginary line and a cover glass, the slope end of the front glass, and the light-output-side end of the light-blocking portion as vertices, for example, according to a fourth embodiment of the present technology.

FIG. 19 is a view illustrating a triangle having the intersection of the first imaginary line and the cover glass, the slope end of the front glass, and the light-output-side end of the light-blocking portion as vertices.

FIG. 20 is a schematic side view illustrating a viewing angle control sheet according to another embodiment (1) of the present technology, which is mounted in a car.

FIG. 21 is a schematic side view illustrating a viewing angle control sheet according to another embodiment (2) of the technology, which is mounted in a car.

### DETAILED DESCRIPTION

### First Embodiment

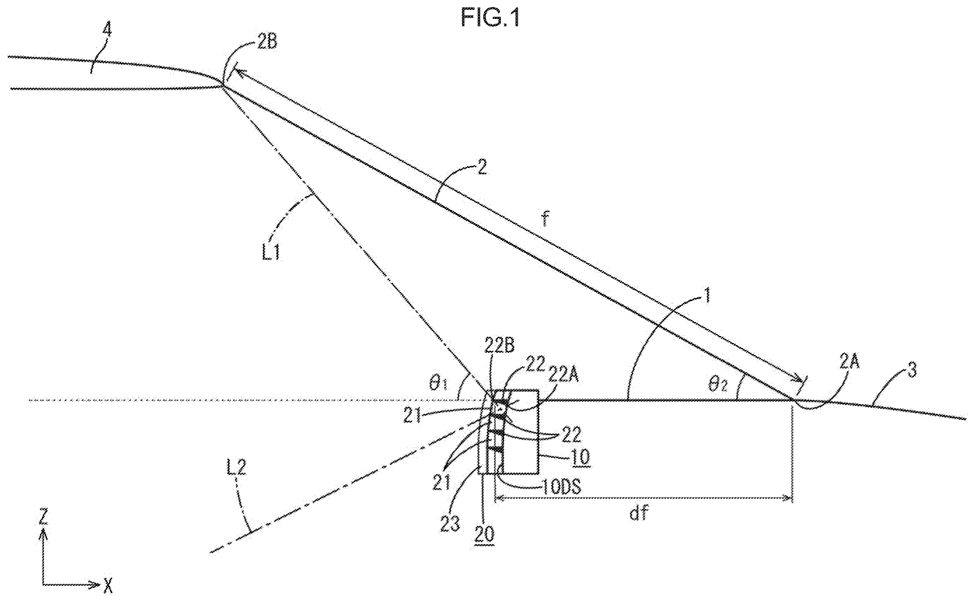

A first embodiment of the present technology is described with reference to FIG. 1 to FIG. 6. In this embodiment, a viewing angle control sheet 20 for a liquid crystal display device (display device) 10 to be mounted in a car is described as an example. The X axis, the Y axis, and the Z axis are indicated in some of the drawings, and each of the axes indicates the same direction in the respective drawings. The Z axis direction substantially matches the vertical direction. The X axis direction and the Y axis direction substantially match the horizontal direction. Furthermore, the upper and lower sides are based on the vertical direction unless otherwise indicated.

First, the liquid crystal display device 10 is described. As illustrated in FIG. 1, the liquid crystal display device 10 is mounted in a dashboard 1 of a car and is located inwardly of a front glass (sloping reflective member) 2 of the car. The front glass 2, which covers the dash board 1 from the upper side, tilts forward and is connected to a hood 3, which is located at the front side of the vehicle (right side in FIG. 1), at a slope origin 2A and connected to a roof 4, which is located at the rear side of the vehicle (left side in FIG. 1) at a slope end 2B. The liquid crystal display device 10, which is mounted in the dashboard 1, is located away from the front glass 2 in the X axis direction (horizontal direction) and the Z axis direction (vertical direction). The liquid crystal display device 10 has a display surface 10DS that displays an image and curves with distance from the front glass 2. The curving direction matches the Z axis direction (vertical direction). Specifically described, the display surface 10DS protrudes toward the rear side of the vehicle (light output side) at a middle portion in the Z axis direction and recedes toward the front side of the vehicle (side opposite the light output side) at end portions in the Z axis direction to form an arc-like overall shape. The liquid crystal display device 10 may be used in a car navigation system, which displays a map, for example, as an image, a multifunction display, which displays an operating state of an air conditioner, for example, as an image in addition to a map, or an instrument panel, which displays indicators and a warning sign, for example, as images, for example. When less external light is applied to the front glass 2, e.g., at night, light in the car reflected by the front glass 2 is more likely to be visually perceived by the user in the car as reflection on the front glass 2.

As illustrated in FIG. 1, the viewing angle control sheet 20 is designed to control the viewing angle of the image on the display surface 10DS of the liquid crystal display device 10 and is located on the light output side of the liquid crystal display device 10. Specifically described, the viewing angle control sheet 20 is attached to the display surface 10DS and curves along the display surface 10DS so as to have the same arc-like shape as the display surface 10DS. The viewing angle control sheet 20 includes light-transmitting portions 21 that transmit light, light-blocking portions 22 that block light, and a sheet support 23 that supports the light-transmitting portions 21 and the light-blocking portions 22. The light-transmitting portions 21 and the light-blocking portions 22 are alternately arranged in the curving direction (Z axis direction) of the display surface 10DS and the viewing angle control sheet 20. The light-transmitting portions 21 are formed of a substantially transparent light-transmitting resin material (light-transmitting material) to transmit light. In contrast, the light-blocking portions 22 are formed of a black light-blocking resin material (light-blocking material), for example, to block light. The sheet support 23 is formed of a light-transmitting resin material that is substantially transparent and transmits light and is located on the light output side of the light-transmitting portions 21 and the light-blocking portions 22. The sheet support 23 extends over the entire area of the viewing angle control sheet 20 across the light-transmitting portions 21 and the light-blocking portions 22 to hold the light-transmitting portions 21 and the light-blocking portions 22.

The light-blocking portions 22 are described in detail. As illustrated in FIG. 1, the light-blocking portions 22 each have a substantially triangular cross-sectional shape and taper toward the light output side. In other words, the light-blocking portion 22 has a wide base 22A, which gives a bottom of the triangle, and a narrow light-output-side end 22B, which gives an apex of the triangle. The light-transmitting portions 21 are each located between two of the light-blocking portions 22 adjacent to each other in the Z axis direction. The two light-blocking portions 22 control the output angle of the light passing through the light-transmitting portion 21. Specifically described, the output angle range of the light passing through the light-transmitting portion 21 is determined by a first straight line L1, which connects the light-output-side end 22B of the light-blocking portion 22 located immediately above the light-transmitting portion 21 and the upper end of the base 22A of the light-blocking portion 22 located immediately below the light-transmitting portion 21, and a second straight light L2, which connects the light-output-side end 22B of the light-blocking portion 22 located immediately below the light-transmitting portion 21 and the lower end of the base 22A of the light-blocking portion 22 located immediately above the light-transmitting portion 21. The first straight line L1 is the optical path of a light ray traveling through the light-transmitting portion 21 at the maximum upward angle or the optical path of a light ray closest to the front glass 2 or the roof 4. If the light traveling on the first straight light L1 reaches the front glass 2 and the user in a car sees the light reflected by the front glass 2, the image on the display surface 10DS would be seen as reflection on the front glass 2, which is a problem. In particular, if a known viewing angle sheet designed for a liquid crystal display device having a flat display surface is used, the flat viewing angle control sheet is curved before use. Such a viewing angle sheet does not properly control the viewing angle and the image is likely to be reflected on the front glass 2.

To solve the problem, the viewing angle control sheet 20 according to the embodiment is configured such that θ1 satisfies the following expression (7) in which, as indicated in FIG. 1, “f” is the length of the front glass 2, “df” is the distance between the slope origin 2A of the front glass 2 and the light-output-side end 22B of the light-blocking portion 22, “θ1” is the maximum elevation angle of light passing through the light-transmitting portion 21, and “θ2” is the elevation angle of the front glass 2. In this configuration, the light traveling on the first straight line L1 does not travel to the front glass 2, and thus the light passing through all the light-transmitting portions 21 does not reach the front glass 2. This does not allow the image on the display surface 10DS to be reflected on the front glass 2. Furthermore, in this embodiment, the distance df is based on the configuration in which the slope origin 2A of the front glass 2 and the light-output-side end 22B of the light-blocking portion 22 is located at substantially the same vertical position.

$$\begin{matrix}[ expr . 7 ] & \\ θ 1 ≦ {cos}^{- 1} ( \frac{f - df \cdot cos θ 2}{\sqrt{{f}^{2} + {df}^{2} - 2 \cdot f \cdot df \cdot cos θ 2}} ) + θ 2 & ( 7 )\end{matrix}$$

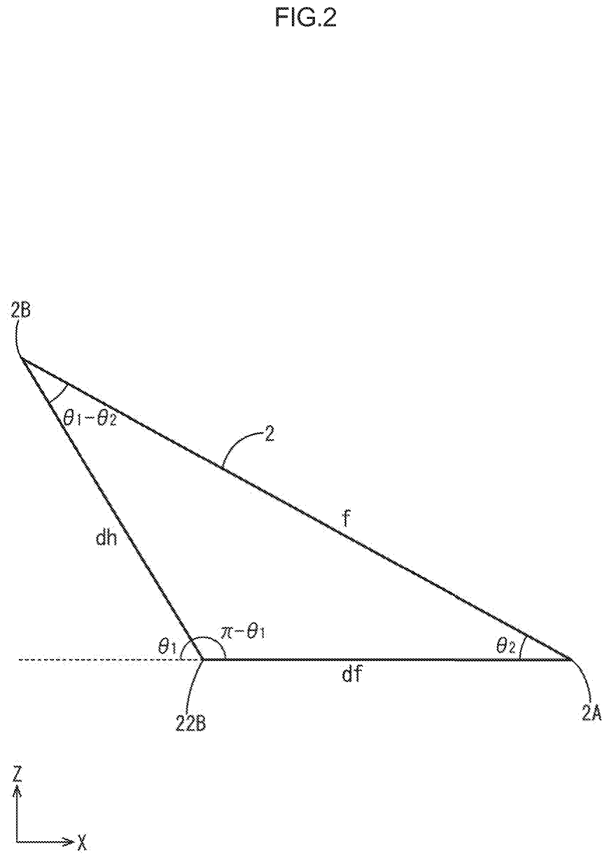

Hereinafter, the method of calculating the above expression (7) is described in detail with reference to FIG. 2. First, FIG. 2 indicates a triangle having the slope origin 2A and the slope end 2B of the front glass 2 and the light-output-side end 22B of the light-blocking portion 22 as vertices. The external angle of the light-output-side end 22B of the light-blocking portion 22, which is the vertex, is defined as “θ1”, the interior angle of the light-output-side end 22B of the light-blocking portion 22 is defined as “n(180°)−θ1”, the interior angle of the slope origin 2A of the front glass 2, which is as the vertex, is defined as “θ2”, and the interior angle of the slope end 2B of the front glass 2 as the vertex is defined as “θ1-θ2”. Furthermore, the length of the side extending from the slope origin 2A to the slope end 2B of the front glass 2 is defined as “f”, the length of the side extending from the slope origin 2A of the front glass 2 to the light-output-side end 22B of the light-blocking portion 22 is defined as “df”, and the length of the side extending from the light-output-side end 22B of the light-blocking portion 22 to the slope end 2B of the front glass 2 is defined as “dh”. The following expressions (8) to (10) are obtained according to the law of cosines.

[expr. 8]

f²=dh²+df²−2·dh·df·cos(π−θ1) (8)

[expr. 9]

dh²=f²+df²−2·f·df·cos θ2 (9)

[expr. 10]

df²=f²+dh²−2·f·dh·cos(θ1−θ2) (10)

The following expression (11) relating to θ1 is obtained from the expression (10). The following expression (12) is obtained by substituting “dh²” in the expression (11) into the expression (9). The expression (12) is a condition of θ1 for the light traveling on the first straight line L1 to reach the slope end 2B of the front glass 2. The value of 81 is the maximum in the range that does not allow the image on the display surface 10DS to be reflected on the front glass 2. The expression (7) that is derived from the expression (12) is a condition for the light traveling on the first straight line L1 to reach the slope end 2B of the front glass 2 or the roof 4. When the condition is satisfied, the image on the display surface 10DS is not reflected on the front glass 2. The expression (13) derived from the expression (12) is a condition for the light traveling on the first straight line L1 to reach the front glass 2. When the condition is satisfied, the image on the display surface 10DS is reflected on the front glass 2.

$$\begin{matrix}[ expr . 11 ] & \\ θ 1 = {cos}^{- 1} ( \frac{{f}^{2} + {dh}^{2} - {df}^{2}}{2 \cdot f \cdot dh} ) + θ 2 & ( 11 ) \\ [ expr . 12 ] & \\ θ 1 = {cos}^{- 1} ( \frac{f - df \cdot cos θ 2}{\sqrt{{f}^{2} + {df}^{2} - 2 \cdot f \cdot df \cdot cos θ 2}} ) + θ 2 & ( 12 ) \\ [ expr . 13 ] & \\ θ 1 > {cos}^{- 1} ( \frac{f - df \cdot cos θ 2}{\sqrt{{f}^{2} + {df}^{2} - 2 \cdot f \cdot df \cdot cos θ 2}} ) + θ 2 & ( 13 )\end{matrix}$$

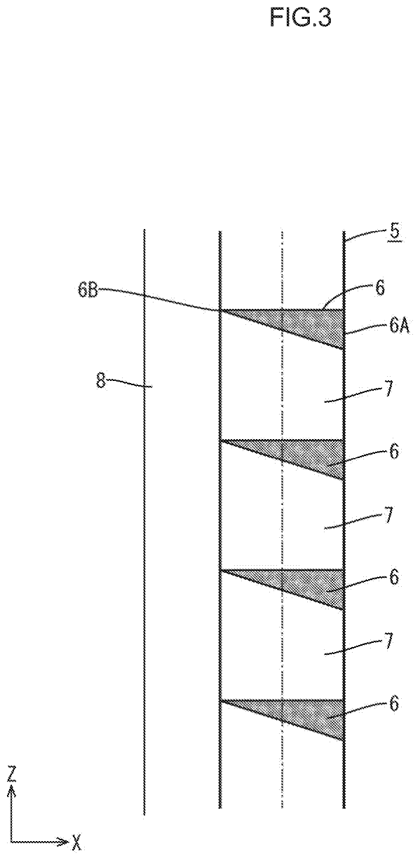

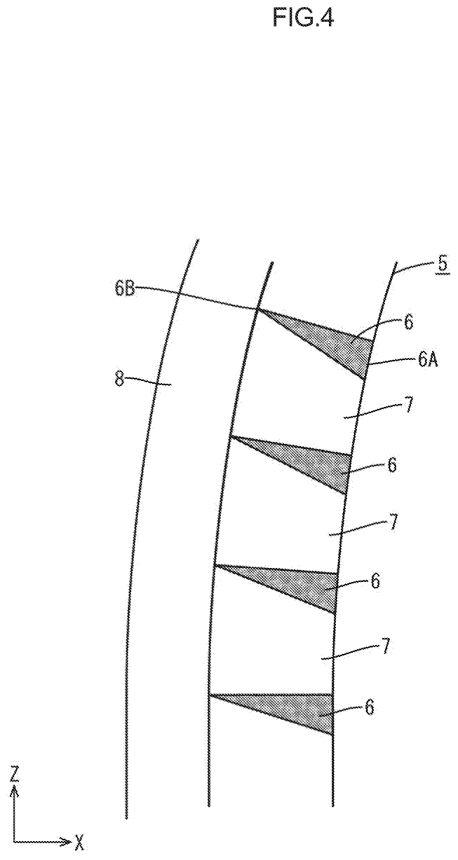

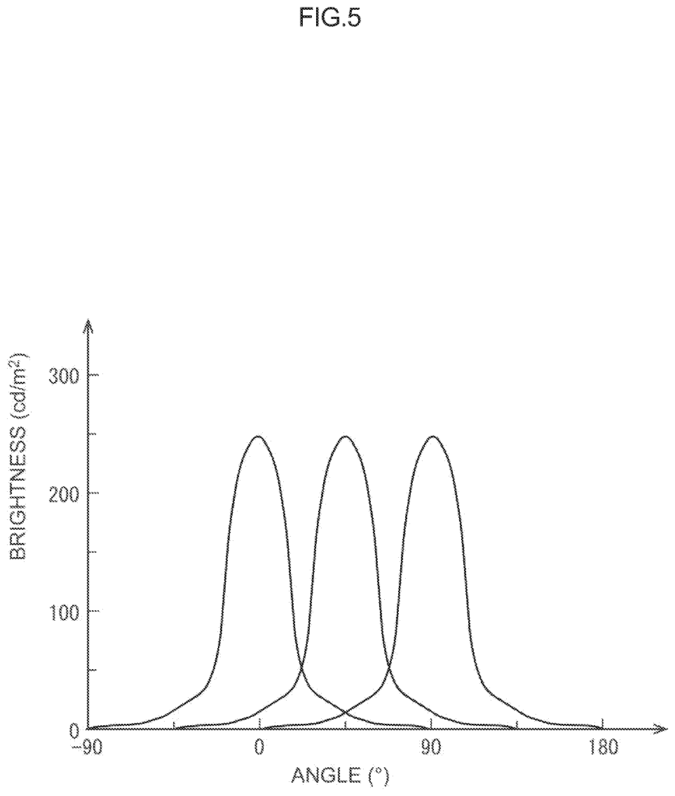

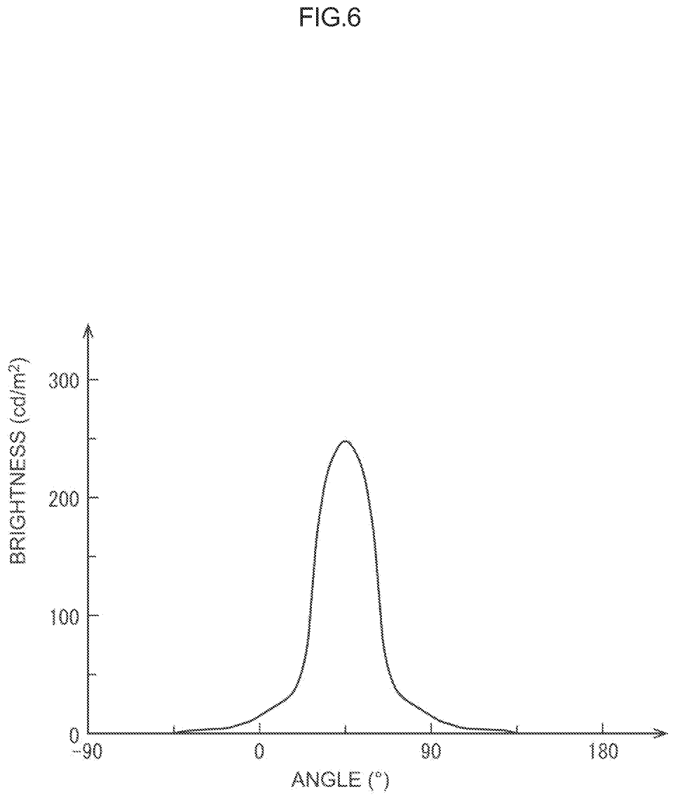

The following is a description of a comparative experiment in which a known viewing angle control sheet 5 designed for a liquid crystal display device having a flat display surface was curved to be used as a comparative example. The viewing angle control sheet 5 of the comparative example before being curved is flat in the Z axis direction as illustrated in FIG. 3. The flat viewing angle control sheet 5 after being curved along the display surface of the liquid crystal display device has a shape illustrated in FIG. 4. The light-output-side end 6B of the light-blocking portion 6 is displaced by the curving to an obliquely upper side relative to the base 6A. Thus, the output angle range of the light from the light-transmitting portion 7 after the curving is larger than that before the curving. The degree of expansion of the output angle range is proportional to the degree of the curve of the viewing angle control sheet 5. The light-blocking portions 6 and the light-transmitting portions 7 are alternately arranged and supported by a sheet support 8. In this comparative experiment, brightness of light from the comparative example, which has the above-described configuration, and brightness of light from the example, which is the viewing angle control sheet 20 having the configuration described before this paragraph, were determined at various angles. Specifically described, in the comparative experiment, the viewing angle control sheets 5 and 20 of the comparative example and the example were curved into a quarter circle having a central angle of 90°, and outgoing light from the viewing angle control sheets 5 and 20 was measured at angles of 0°, 45°, and 90° with respect to the horizontal direction (X axis direction) (0°). The angle of 90° corresponds to the vertical direction (Z axis direction). FIG. 5 indicates a brightness and angle distribution of the comparative example. FIG. 6 indicates a brightness and angle distribution of the example. In each of FIG. 5 and FIG. 6, the horizontal axis of the graph represents angles (°) and the vertical axis of the graph represents brightness (cd/m²). As can be seen from FIG. 5, in the comparative example, the brightness and angle distribution shows different measurement results at angles of 0°, 45°, and 90° and the outgoing light have at least three brightness peaks at 0°, 45°, and 90°. This indicates that the outgoing light from the viewing angle control sheet 5 according to the comparative example is diffused over a large area and the viewing angle is not properly controlled, and thus some of the light is likely to travel to the front glass 2. This readily allows an image to be reflected on the front glass 2. In contrast, as can be seen from FIG. 6, the brightness and angle distribution was substantially the same for angles of 0°, 45°, and 90°, and the outgoing light has only one brightness peak at about 450. This indicates that the output angle range of the outgoing light from the viewing angle control sheet 20 according to the example is properly limited and the viewing angle is properly controlled, and thus no light does travel to the front glass 2. This does not allow an image to be reflected on the front glass 2.

As described above, the viewing angle control sheet 20 according to the embodiment is located inwardly of the front glass (sloping reflective member) 2 that tilts forward and reflects light and located on the light output side of the liquid crystal display device (display device) 10 having the display surface 10DS curving in accordance with distance from the front glass 2. The viewing angle control sheet 20 is curved along the display surface 10DS so as to control a viewing angle of an image displayed on the display surface 10DS. The viewing angle control sheet 20 includes the light-transmitting portions 21, which transmit light, and the light-blocking portions 22, which block light, alternately arranged in the curving direction of the display surface 10DS. The light viewing angle control sheet 20 is configured such that θ1 satisfies the above expression (7), in which “f” is the length of the front glass 2, “df” is the distance between the slope origin 2A of the front glass 2 and the light-output-side end 22B of the light-blocking portion 22, “θ1” is a maximum elevation angle of light passing through the light-transmitting portions 21, and “θ2” is an elevation angle of the front glass 2.

In this configuration, an image is displayed by using outgoing light from the display surface 10DS of the liquid crystal display device 10, and the output angle of the outgoing light is controlled by the viewing angle control sheet 20 located on the light-output side of the liquid crystal display device 10. Specifically described, in the viewing angle control sheet 20 including the light-transmitting portions 21 and the light-blocking portions 22 alternately arranged in the curving direction of the display surface 10DS, the output angle of light passing through the light-transmitting portions 21 is controlled by the light-blocking portions 22 adjacent to the light-transmitting portions 21. Here, the liquid crystal display device 10 is located inwardly of the front glass 2, which tilts forward and reflects light. A viewing angle control sheet 20 designed to be used in a flat state may be curved and used as the viewing angle control sheet 20 curving along the display surface 10DS, which curves in accordance with distance from the front glass 2. However, in such a case, the output angle of light passing through the light-transmitting portion 21 is not properly controlled and some of the output light may reach and reflect off the front glass 2, resulting in that the image on the display surface 10DS is reflected on the front glass 2. To solve the problem, the viewing angle control sheet 20 is configured such that the maximum elevation angle θ1 of light passing through the light-transmitting portion 21 satisfies the above expression (7). This does not allow the light passing through the light-transmitting portion 21 to reach the front glass 2. Thus, the image on the display surface 10DS is not reflected on the front glass 2. In particular, this is advantageous for a display surface 10DS and a viewing angle control sheet 20 that have a complex curve.

### Second Embodiment

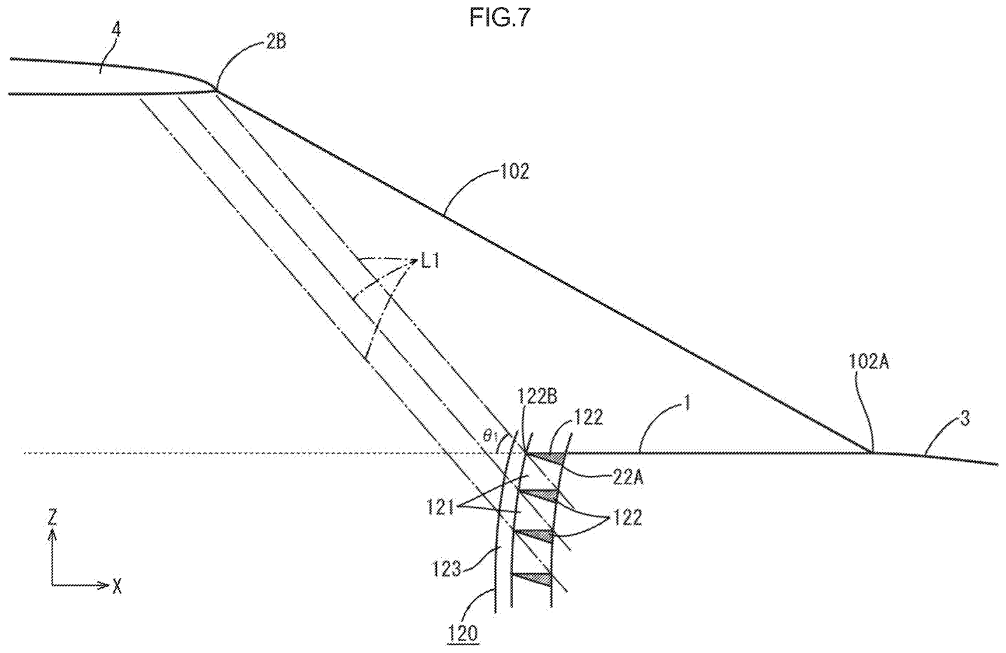

A second embodiment of the present technology is described with reference to FIG. 7 to FIG. 15. In the second embodiment, a viewing angle control sheet 120, for example, has a different configuration. The same components, effects, and advantages as those in the first embodiment are not repeatedly described.

As illustrated in FIG. 7, the viewing angle control sheet 120 according to this embodiment is configured such that the maximum elevational angle θ1 is the same for all the light rays passing through the light-transmitting portions 121. Thus, the light rays traveling on the first straight lines L1 through the light-transmitting portions 121 are parallel to each other. In this embodiment, the value of the maximum elevational angle θ1 is determined based on the top light-transmitting portion 121 nearest to the front glass 102. In this configuration, all the light rays passing though the light-transmitting portions 121 do not reach the front glass 102. This configuration makes the design and the production easy, because the maximum elevation angles θ1 of the light rays passing through the light-transmitting portions 121 only need to be adjusted to be the same. In FIG. 7, the liquid crystal display device is not illustrated.

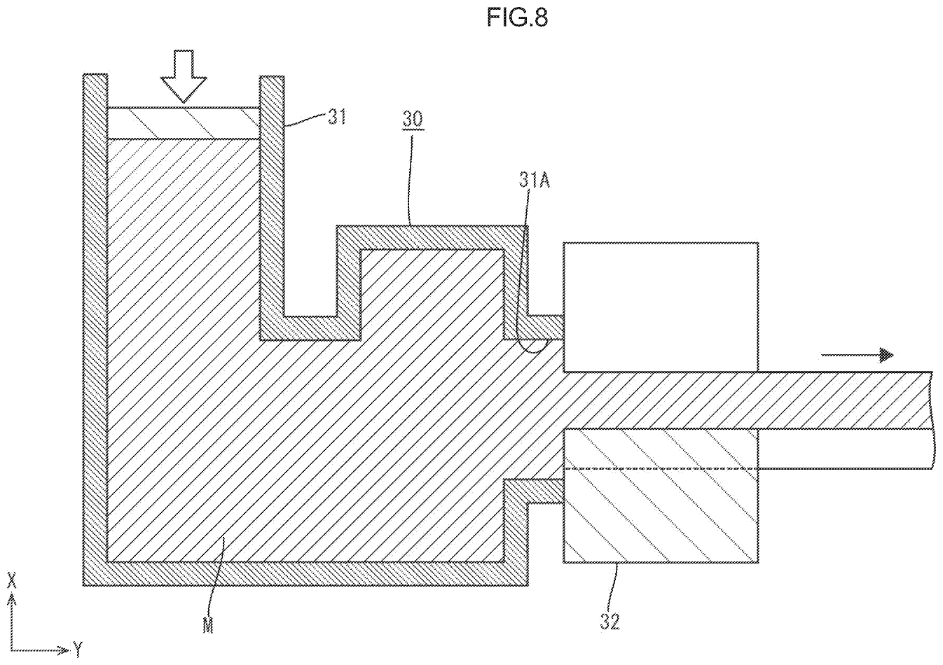

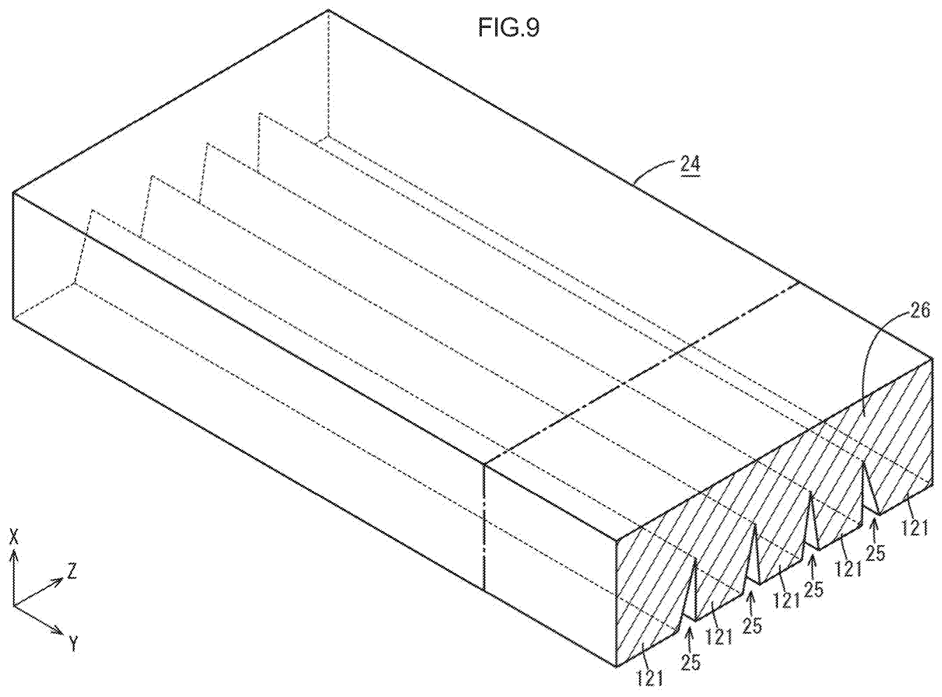

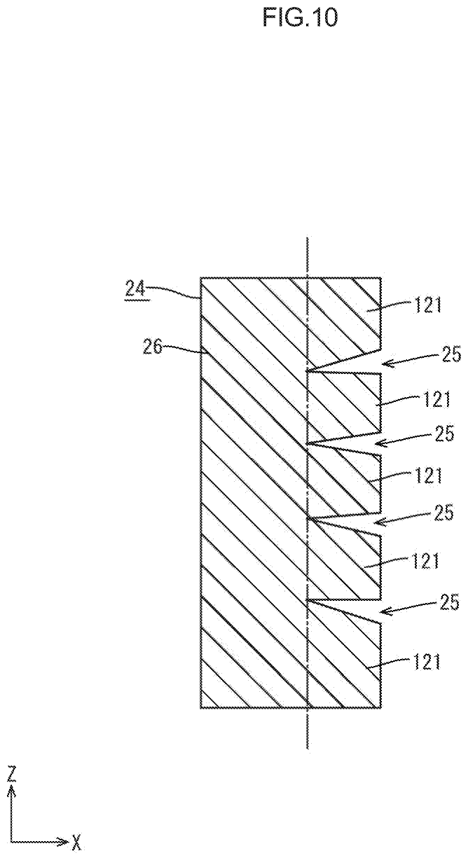

Next, a method of producing the viewing angle control sheet 120 according to this embodiment is described. The method of producing the viewing angle control sheet 120 includes a sheet formation process of forming a flat viewing angle control sheet 120 and a curving process of curving the flat viewing angle control sheet 120. First, as illustrated in FIG. 8, an extruder 30 is used in the sheet formation process. The extruder 30 includes an extruder body 31, which is filled with a molten resin material M, and a forming die 32, which is located on an opening 31A of the extruder body 31. When a pressure is applied to the light-transmitting resin material M in the body 31 from the side opposite the opening 31A, the light-transmitting resin material M is pushed out through the opening 31A into the forming die 32. The forming die 32 has a molding surface that has a transferred shape of the light-transmitting portions 121 of the viewing angle control sheet 120, and thus the light-transmitting resin material M pushed out into the die 32 has the shape corresponding to the molding surface. The light-transmitting resin material M pushed out in the Y axis direction in FIG. 8 is cured and then cut into pieces to obtain a continuous light-transmitting portion 24 illustrated in FIG. 9 and FIG. 10. As illustrated in FIG. 9 and FIG. 10, the continuous light-transmitting portion 24 includes multiple light-transmitting portions 121 with spaces 25 therebetween. The continuous light-transmitting portion 24 has a retainer 26 that holds the light-transmitting portions 121 having the spaces 25 therebetween.

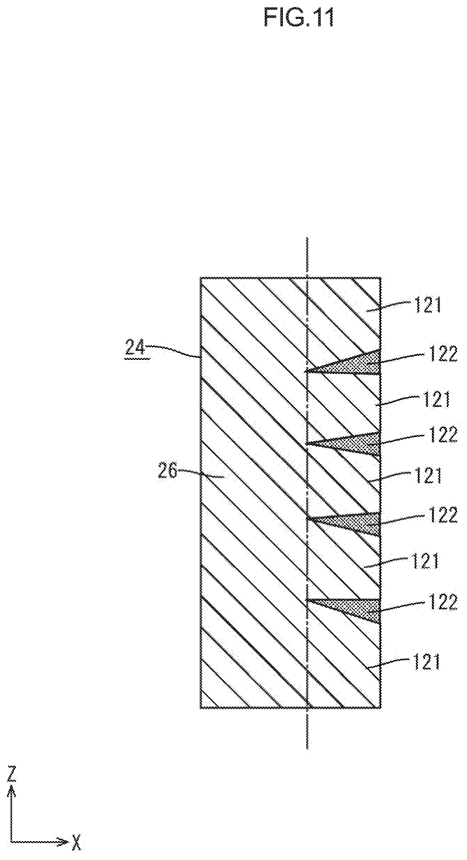

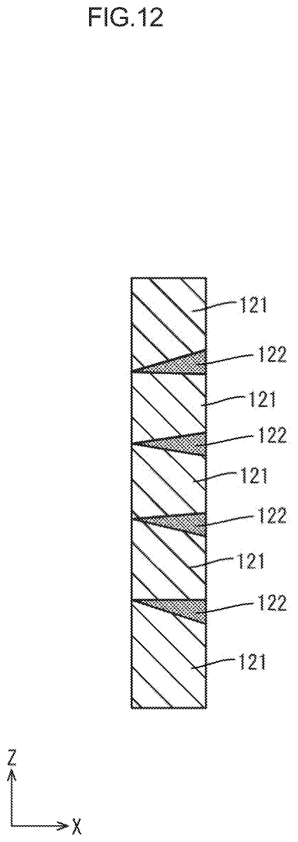

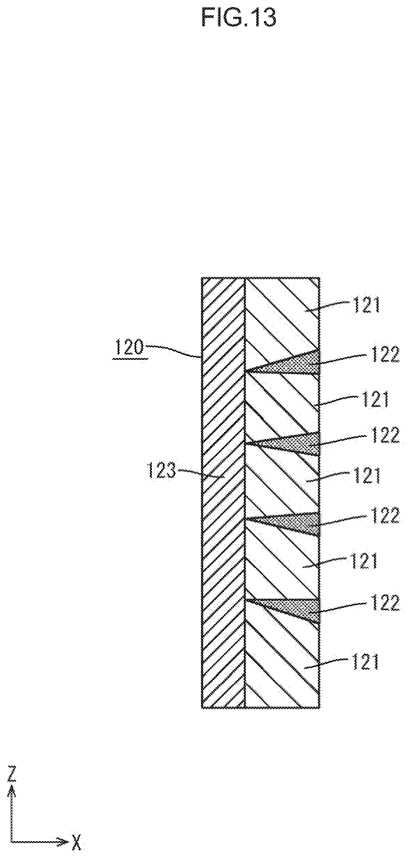

In the sheet formation process, the spaces 25 between the adjacent light-transmitting portions 121 of the continuous light-transmitting portion 24 are filled with a light-blocking resin material to form the light-blocking portions 122 illustrated in FIG. 11. Then, as illustrated in FIG. 12, the retainer 26 is removed, and then a sheet support 123 is attached as illustrated in FIG. 13. In this way, a flat viewing angle control sheet 120 in which the light-transmitting portions 121 and the light-blocking portions 122 are alternately arranged and supported by the sheet support 123 is obtained. The light-blocking portions 122 of the flat viewing angle control sheet 120 produced in this sheet formation process are arranged in view of the amount of displacement caused by the following curving process in which the viewing angle control sheet 120 is curved. Thus, in the continuous light-transmitting portion 24 formed by using the resin in the sheet formation process, the arrangement of the spaces 25 adjacent to the light-transmitting portions 121 corresponds to the arrangement of the light-blocking portions 122. The sheet formation process according to this embodiment employs the extrusion process to form the continuous light-transmitting portion 24 having the above-described configuration, resulting in a higher degree of arrangement freedom of the spaces 25, compared with an injection molding process.

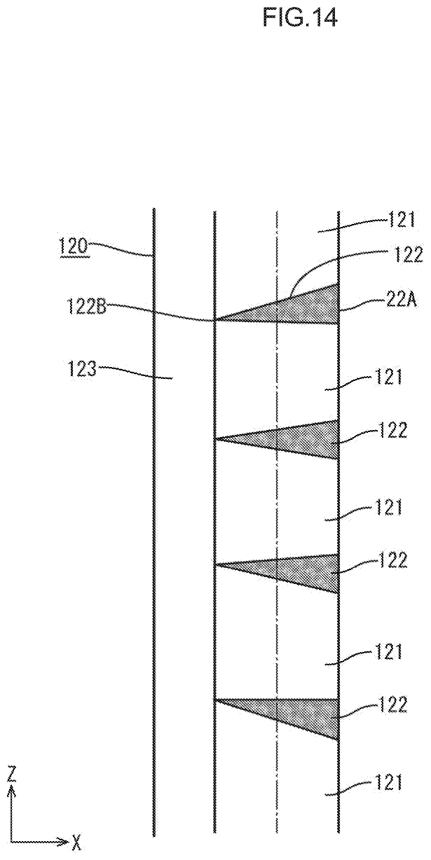

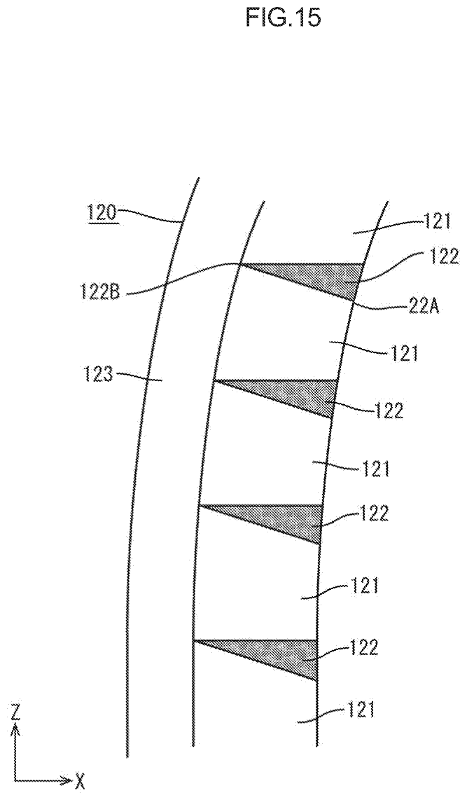

In the curving process, the flat viewing angle control sheet 120 illustrated in FIG. 14 is curved along the display surface of the liquid crystal display device. At this time, the flat viewing angle control sheet 120 is curved such that the light rays passing through the light-transmitting portions 121 have the same maximum elevation angle θ1 and the expression (7) in the first embodiment is satisfied. Thus, the curved viewing angle control sheet 120 illustrated in FIG. 15 is obtained. The continuous light-transmitting portion 24 is designed backward from the shape of the curved viewing angle control sheet 120 and formed by using resin in the sheet formation process. This allows the light rays passing through the light-transmitting portions 121 to have the same maximum elevation angle θ1 with high reliability.

As described above, in the viewing angle control sheet 120 according to this embodiment, the value of θ1 is the same for all the light-transmitting portions 121. This configuration does not allow the light passing through the light-transmitting portions 121 to reach the front glass 102. This makes the design and the production easy, because the maximum elevation angles θ1 of the light rays passing through the light-transmitting portions 121 only need to be adjusted to be the same.

Furthermore, the method of producing the viewing angle control sheet 120 according to this embodiment includes the sheet formation process of forming a flat viewing angle control sheet 120 including the light-transmitting portions 121 that transmit light and the light-blocking portions 122 that block light in an alternating arrangement, and a curving process of curving the flat viewing angle control sheet 120 along the display surface of the liquid crystal display device, which is located inwardly of the front glass 102 that tilts forward and reflects light. The display surface curves in accordance with distance from the front glass 102. The flat viewing angle control sheet 120 is curved in the curving process such that θ1 satisfies the expression (7) in the first embodiment, in which “f” is the length of the front glass 102, “df” is the distance between the slope origin 102A of the front glass 102 and the light-output-side end 122B of the light-blocking portion 122, “θ1” is the maximum elevation angle of light passing through the light-transmitting portion 121, and “θ2” is the elevation angle of the front glass 102.

First, the sheet formation process forms the flat viewing angle control sheet 120 including the light-transmitting portions 121 that transmit light and the light-blocking portions 122 that block light in an alternating arrangement. The curving process curves the flat viewing angle control sheet 120 along the display surface of the liquid crystal display device. The liquid crystal display device is located inwardly of the front glass 102, which tilts forward and transmit light. A viewing angle control sheet 120 designed to be used in a flat state may be curved and used as the viewing angle control sheet 120 curving along the display surface, which curves in accordance with distance from the front glass 102. However, in such a case, the output angle of light passing through the light-transmitting portion 121 is not properly controlled and some of the output light may reach and reflect off the front glass 102, resulting in that the image on the display surface is reflected on the front glass 102. To solve the problem, the viewing angle control sheet 120 is curved such that the maximum elevation angle θ1 of light passing through the light-transmitting portion 121 satisfies the above expression (7). This does not allow the light passing through the light-transmitting portion 121 to reach the front glass 102. Thus, the image on the display surface is not reflected on the front glass 102. In particular, this is advantageous for a display surface and a viewing angle control sheet 120 that have a complex curve.

Furthermore, in the sheet formation process of the method of producing the viewing angle control sheet 120 according to this embodiment, the continuous light-transmitting portion 24 including the light-transmitting portions 121 having the spaces 25 therebetween is formed by the extrusion molding using resin, and then the spaces 25 between the adjacent light-transmitting portions 121 of the continuous light-transmitting portion 24 are filled with a light-blocking material to form the light-blocking portions 122. The light-blocking portions 122 of the flat viewing angle control sheet 120 produced in this sheet formation process are arranged in view of the amount of displacement caused by the curving process in which the viewing angle control sheet 120 is curved. Thus, in the continuous light-transmitting portion 24 formed by using resin in the sheet formation process, the arrangement of the spaces 25 adjacent to the light-transmitting portions 121 corresponds to the arrangement of the light-blocking portions 122. The sheet formation process according to this embodiment employs the extrusion process to form the continuous light-transmitting portion 24 having the above-described configuration, resulting in a higher degree of arrangement freedom of the spaces 25, compared with an injection molding process. As described above, after the flat viewing angle control sheet 120 is obtained in the sheet formation process by using the continuous light-transmitting portion 24 formed by the extrusion process, the flat viewing angle control sheet 120 is curved in the curving process, enabling the maximum elevation angle θ1 of the light passing through the light-transmitting portion 121 to satisfy the expression (7) in the first embodiment.

### Third Embodiment

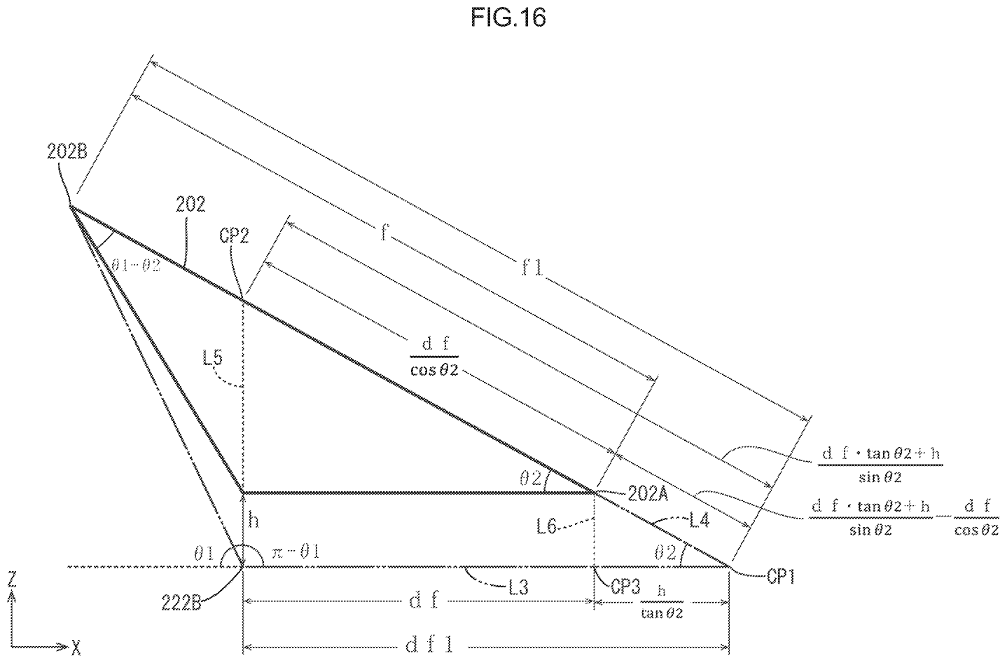

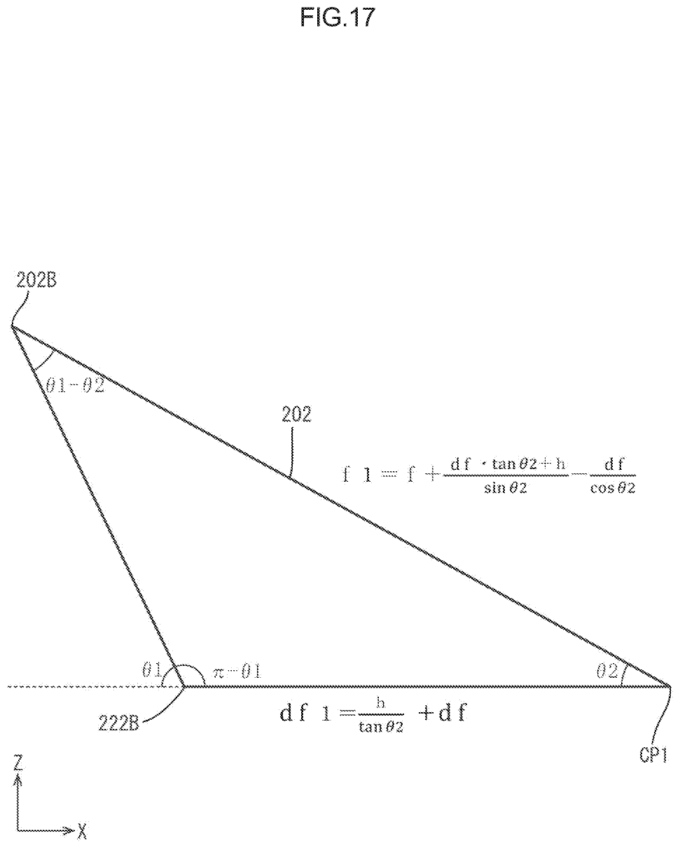

A third embodiment of the present technology is described with reference to FIG. 16 or FIG. 17. In the third embodiment, the position of a light-output-side end 222B of the light-blocking portion differs from that in the first embodiment. The same components, effects, and advantages as those in the first embodiment are not repeatedly described.

As illustrated in FIG. 16, the light-output-side end 222B of the light-blocking portion according to this embodiment is located below a slope origin 202A in the vertical direction, i.e., located away from the slope origin 202A on an opposite side of the slope origin 202A from a slope end 202B of a front glass 202. A first imaginary line L3 extends in the horizontal direction and passes through the light-blocking portion. A second imaginary line L4 is an extension of the front glass 202 extended from the slope origin 202A toward the side away from the slope end 202B. The imaginary lines L3 and L4 intersect at an intersection CP1. In this embodiment, the distance between the intersection CP1 and the light-output-side end 222B of the light-blocking portion is defined as “df1”, the distance between the slope end 202B of the front glass 202 and the intersection CP1 is defined as “f1”, and the distance between the slope origin 202A of the front glass 202 and the light-output-side end 222B of the light-blocking portion in the vertical direction is defined as “h”. The length f of the front glass 202 and the distance df between the slope origin 202A of the front glass 202 and the light-output-side end 222B of the light-blocking portion satisfy the following expressions (14) and (15). The maximum elevation angle θ1 of light passing through the light-transmitting portion is obtained by substituting df and f obtained based on the expressions (14) and (15) in the expression (7) in the first embodiment. The viewing angle control sheet formed based on the maximum elevation angle θ1 is able to prevent reflection.

$$\begin{matrix}[ expr . 14 ] & \\ f 1 = f + \frac{df \cdot tan θ 2 + h}{sin θ 2} - \frac{df}{cos θ 2} & ( 14 ) \\ [ expr . 15 ] & \\ df 1 = \frac{h}{tan θ 2} + df & ( 15 )\end{matrix}$$

Hereinafter, methods of calculating the expressions (14) and (15) are described. First, the method of calculating the expression (14) is described. As illustrated in FIG. 16, a first auxiliary line L5 extending in the vertical direction through the light-output-side end 222B is drawn to obtain an intersection CP2 of the first auxiliary line L5 and the front glass 202. The distance between the slope origin 202A of the front glass 202 and the intersection CP2 is represented by the following expression (16). The distance between the intersection CP1 and the intersection CP2 is represented by the following expression (17), and thus the distance between the slope origin 202A of the front glass 202 and the intersection CP1 is represented by the following expression (18). Thus, as indicated in FIG. 17, the distance f1 between the slope end 202B of the front glass 202 and the intersection CP1 is represented by the expression (14). Next, the method of calculating the expression (15) is described. As illustrated in FIG. 16, a second auxiliary line L6 extending in the vertical direction through the slope origin 202A of the front glass 202 is drawn to obtain an intersection CP3 of the second auxiliary line L6 and the first imaginary line L3. The distance between the intersection CP1 and the intersection CP3 is represented by the following expression (19). Thus, as indicated in FIG. 17, the distance df1 between the light-output-side end 222B of the light-blocking portion and the intersection CP1 is represented by the above expression (15).

$$\begin{matrix}[ expr . 16 ] & \\ \frac{df}{cos θ 2} & ( 16 ) \\ [ expr . 17 ] & \\ \frac{df \cdot tan θ2 + h}{sin θ 2} & ( 17 ) \\ [ expr . 18 ] & \\ \frac{df \cdot tan θ2 + h}{sin θ 2} - \frac{df}{cos θ 2} & ( 18 ) \\ [ expr . 19 ] & \\ \frac{h}{tan θ 2} & ( 19 )\end{matrix}$$

As described above, according to this embodiment, the light-blocking portion is located away from the slope origin 202A of the front glass 202 in the horizontal direction and located away from the slope origin 202A on an opposite side of the slope origin 202A from the slope end 202B of the front glass 202 in the vertical direction, and df and f satisfy the above expressions (14) and (15), in which “df1” is a distance between the intersection CP1 of the first imaginary line L3, which extends in the horizontal direction through the light-blocking portion, and the second imaginary line L4, which is an extension of the front glass 202 extended from the slope origin 202A toward a side away from the slope end 202B, and the light-output-side end 222B of the light-blocking portion, “f1” is the distance between the slope end 202B of the front glass 202 and the intersection CP1, and “h” is the distance between the slope origin 202A of the front glass 202 and the light-output-side end 222B of the light-blocking portion in the vertical direction.

In this configuration in which the light-blocking portion located away from the slope origin 202A of the front glass 202 in the horizontal direction is located away from the slope origin 202A of the front glass 202 in the vertical direction on an opposite side of the slope origin 202A of the front glass 202 from the slope end 202B, the maximum elevation angle θ1 of the light passing through the light-transmitting portion is determined in view of the distance h between the slope origin 202A and the light-output-side end 222B of the light-blocking portion. Specifically described, first, the intersection CP1 of the first imaginary line L3, which extends in the horizontal direction through the light-transmitting portion, and the second imaginary line L4, which is an extension of the front glass 202 extended from the slope origin 202A toward a side away from the slope end 202B, is set. Based on the expressions (14) and (15) including the distance df1 between the intersection CP1 and the light-output-side end 222B and the distance f1 between the slope end 202B of the front glass 202 and the intersection CP1, df and f are obtained. The maximum elevation angle θ1 of light passing through the light-transmitting portion is obtained by substituting df and f obtained in this way in the expression (7) in the first embodiment. The viewing angle control sheet formed based on θ1 is able to prevent reflection.

### Fourth Embodiment

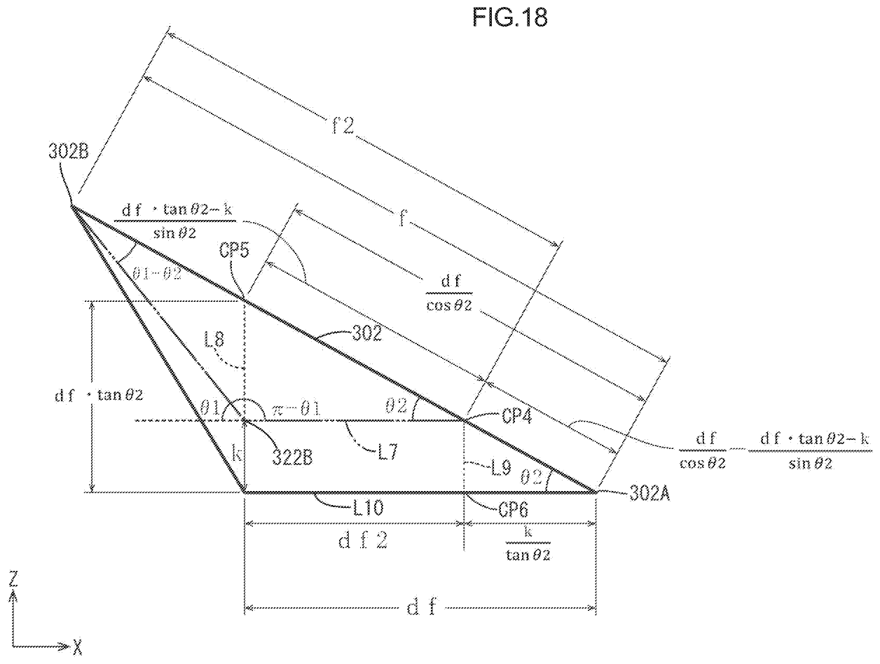

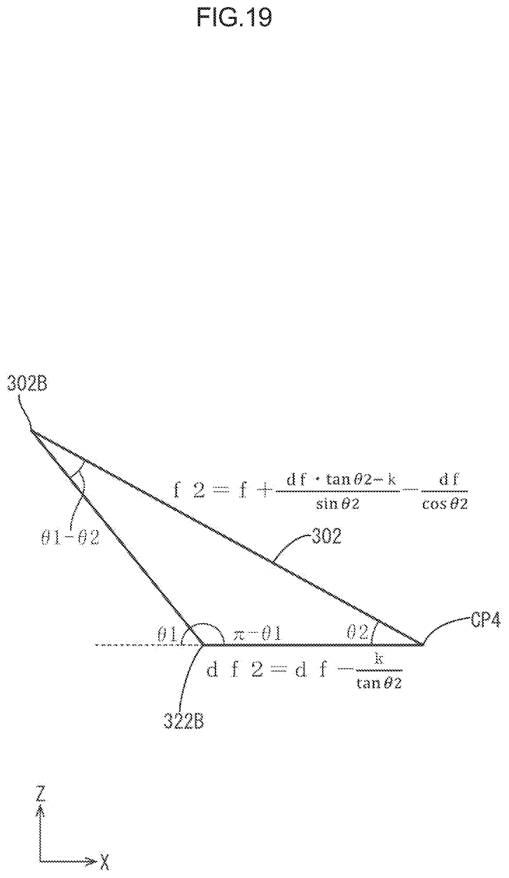

A fourth embodiment of the present technology is described with reference to FIG. 18 or FIG. 19. In the fourth embodiment, a position of a light-output-side end 322B differs from that in the first embodiment. The same components, effects, and advantages as those in the first embodiment are not repeatedly described.

As illustrated in FIG. 18, the light-output-side end 322B of the light-blocking portion according to this embodiment is located above the slope origin 302A in the vertical direction, i.e., located away from the slope origin 302A on a side adjacent to the slope end 302B of the front glass 302. A first imaginary line L7 extends in the horizontal direction through the light-blocking portion. The first imaginary line L7 and the front glass 302 intersect at an intersection CP4. In this embodiment, the distance between the intersection CP4 and the light-output-side end 322B is defined as “df2”, the distance between the slope end 302B of the front glass 302 and the intersection CP4 is defined as “f2”, and the distance between the slope origin 302A of the front glass 302 and the light-output-side end 322B of the light-blocking portion in the vertical direction is defined as “k”. At this time, the length f of the front glass 302 and the distance df between the slope origin 302A of the front glass 302 and the light-output-side end 322B of the light-blocking portion satisfy the following expressions (20) and (21). The maximum elevation angle θ1 of light passing through the light-transmitting portion is obtained by substituting df and f obtained based on the expressions (20) and (21) in the expression (7) in the first embodiment. The viewing angle control sheet formed based on the maximum elevation angle θ1 is able to prevent reflection.

$$\begin{matrix}[ expr . 20 ] & \\ f 2 = f + \frac{df \cdot tan θ 2 - k}{sin θ 2} - \frac{df}{cos θ 2} & ( 20 ) \\ [ expr . 21 ] & \\ df 2 = df - \frac{k}{tan θ 2} & ( 21 )\end{matrix}$$

Hereinafter, the methods of calculating the above expressions (20) and (21) are described. First, the method of calculating the expression (20) is described. As illustrated in FIG. 18, a first auxiliary line L8 extending in the vertical direction through the light-output-side end 322B is drawn to obtain an intersection CP5 of the first auxiliary line L8 and the front glass 302. The distance between the slope origin 302A of the front glass 302 and the intersection CP5 is as represented by the above expression (16). The distance between the intersection CP4 and the intersection CP5 is represented by the following expression (22), and thus the distance between the slope end 302A of the front glass 302 and the intersection CP5 is represented by the following expression (23). Thus, the distance f2 between the slope end 302B of the front glass 302 and the intersection CP4 is represented by the above expression (20) as indicated in FIG. 19. Next, the method of calculating the expression (21) is described. As indicated in FIG. 18, a second auxiliary line L9 extending in the vertical direction through the intersection CP4 and a third auxiliary line L10 extending in the horizontal direction through the slope origin 302A of the front glass 302 are drawn to obtain an intersection CP6 of the second auxiliary line L9 and the third auxiliary line L10. The distance between the slope origin 302A of the front glass 302 and the intersection CP6 is represented by the following expression (24). Thus, the distance df2 between the light-output-side end 322B of the light-blocking portion and the intersection CP4 is represented by the above expression (21) as indicated in FIG. 19.

$$\begin{matrix}[ expr . 22 ] & \\ \frac{df \cdot tan θ2 - k}{sin θ 2} & ( 22 ) \\ [ expr . 23 ] & \\ \frac{df}{cos θ 2} - \frac{df \cdot tan θ2 - k}{sin θ 2} & ( 23 ) \\ [ expr . 24 ] & \\ \frac{k}{tan θ 2} & ( 24 )\end{matrix}$$

As described above, according to this embodiment, the light-blocking portion is located away from the slope origin 302A of the front glass 302 in the horizontal direction and located away from the slope origin 302A in the vertical direction on a side of the slope origin 302A adjacent to the slope end 302B of the front glass 302, and df and f satisfy he above expressions (20) and (21) in which “df2” is a distance between the intersection CP4 of the first imaginary line L7 extending in the horizontal direction through the light-blocking portion and the front glass 302 and the light-output-side end 322B of the light-blocking portion, “f2” is the distance between the slope end 302B of the front glass 302 and the intersection CP4, and “k” is the space between the slope origin 302A of the front glass 302 and the light-output-side end 322B of the light-blocking portion in the vertical direction.

In this configuration in which the light-blocking portion located away from the slope origin 302A of the front glass 302 in the horizontal direction is located away from the slope origin 302A in the vertical direction on a side of the slope origin 302A of the front glass 302 adjacent to the slope end 302B, the maximum elevation angle θ1 of the light passing through the light-transmitting portion is determined in view of the distance k between the slope origin 302A and the light-output-side end 322B of the light-blocking portion in the vertical direction. Specifically described, first, the intersection CP4 of the first imaginary line L7, which extends in the horizontal direction through the light-transmitting portion, and the front glass 302 is set. Based on the expressions (20) and (21) including the distance df2 between the intersection CP4 and the light-output-side end 322B and the distance f2 between the slope end 302B of the front glass 302 and the intersection CP4, df and f are obtained. The maximum elevation angle θ1 of light passing through the light-transmitting portion is obtained by substituting df and f obtained in this way in the expression (7) in the first embodiment. The viewing angle control sheet formed based on θ1 is able to prevent reflection.

### OTHER EMBODIMENTS

The present technology is not limited to the embodiments described above and with reference to the drawing. The following embodiments may be included in the technical scope.

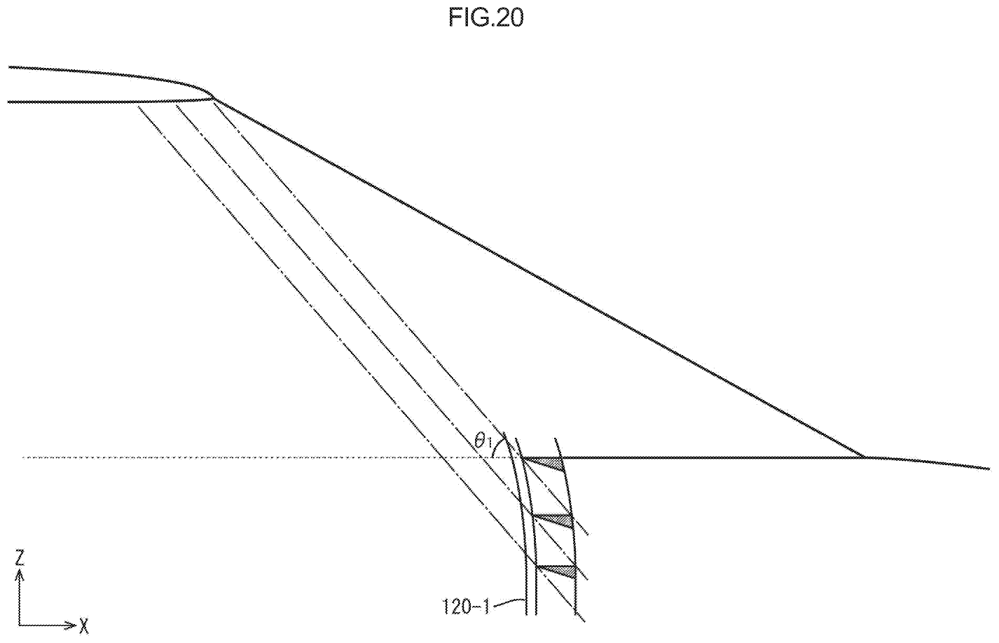

(1) A viewing angle control sheet 120-1 having a curve illustrated in FIG. 20 may be used as a first modification of the second embodiment. The viewing angle control sheet 120-1 curves such that the middle in the Z axis direction recedes toward the front side of the vehicle and end portions in the Z axis direction protrude toward the rear side of the vehicle.

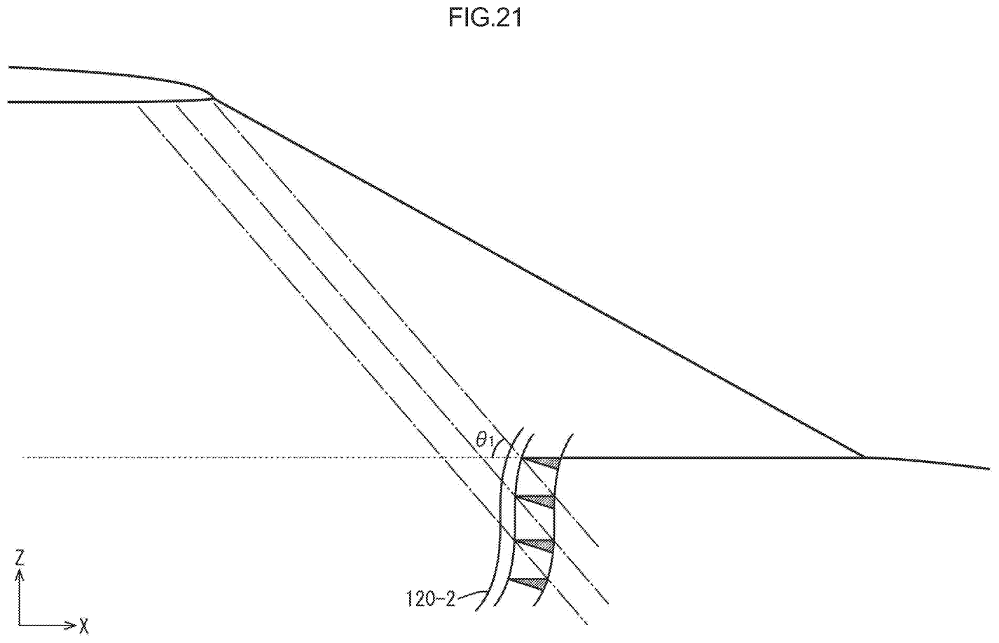

(2) A viewing angle control sheet 120-2 having a curve illustrated in FIG. 21 may be used as a second modification of the second embodiment. The viewing angle control sheet 120-2 has a corrugated cross-sectional shape.

(3) Other than the above embodiments, for example, a multifunction display mounted on a dashboard of a car without side view mirrors may display side view mirror images. In such a case, the installation area of the multifunction display preferably has a width substantially equal to the full width of the dashboard, but the width is not limited thereto.

(4) In the above embodiments, the curve of the viewing angle control sheet is substantially the same as that of the curved display surface of the liquid crystal display device. However, the curve of the viewing angle control sheet may differ from that of the curved display surface of the liquid crystal display device.

(5) The specific shape of the curve of the viewing angle control sheet may be suitably changed from those described in the above embodiments.

(6) In the second embodiment, the light rays passing through the multiple light-transmitting portions have the same maximum elevation angle θ1. However, the light rays passing through the multiple light-transmitting portions may have different maximum elevation angles θ1. In such a case, the maximum elevation angles θ1 still need to satisfy the expression (7).

(7) In the example of the production method described in the second embodiment, a flat viewing angle control sheet is formed first, and then the flat viewing angle control sheet is curved. However, a different method may be employed to produce the curved viewing angle control sheet. For example, a curved continuous light-transmitting portion may be formed in the sheet formation process, and a light-blocking resin material may fill the spaces in the continuous light-transmitting portion to form the light-blocking portions.

(8) The specific number of light-transmitting portions or light-blocking portions of the viewing angle control sheet and the cross-sectional shape thereof may be suitably changed from those in the drawings of the embodiments.

(9) In the above embodiments, the display surface of the liquid crystal display device and the viewing angle control sheet curve in the vertical direction. However, the display surface of the liquid crystal display device and the viewing angle control sheet may curve in the horizontal direction in addition to the vertical direction.

(10) In the above embodiments, the liquid crystal display device is described as an example of the display device. However, other types of display device such as an organic EL display device may be used.

1. A viewing angle control sheet located inwardly of a sloping reflective member that tilts forward and reflects light and located on a light output side of a display device having a display surface curving in accordance with distance from the sloping reflective member, the viewing angle control sheet being curved along the display surface so as to control a viewing angle of an image displayed on the display surface, the viewing angle control sheet comprising:
light-transmitting portions, which transmit light, and light-blocking portions, which block light, alternately arranged in a curving direction of the display surface, wherein
the light viewing angle control sheet is configured such that θ1 satisfies the following expression (1),
$$\begin{matrix}[ expr . 1 ] & \\ θ 1 ≦ {cos}^{- 1} ( \frac{f - df \cdot cos θ 2}{\sqrt{{f}^{2} + {df}^{2} - 2 \cdot f \cdot df \cdot cos θ 2}} ) + θ 2 & ( 1 )\end{matrix}$$
in which “f” is a length of the sloping reflective member, “df” is a distance between a slope origin of the sloping reflective member and a light-output-side end of the light-blocking portions, “θ1” is a maximum elevation angle of light passing through the light-transmitting portions, and “θ2” is an elevation angle of the sloping reflective member.

2. The viewing angle control sheet according to claim 1, wherein θ1 is the same value for all the light-transmitting portions.

3. The viewing angle control sheet according to claim 1, wherein the light-blocking portions are located away from the slope origin of the sloping reflective member in a horizontal direction and located away from the slope origin in a vertical direction on an opposite side of the slope origin from a slope end of the sloping reflective member, and
df and f satisfy the following expressions (2) and (3),
$$\begin{matrix}[ expr . 2 ] & \\ f = f 1 - \frac{df \cdot tan θ 2 + h}{sin θ 2} + \frac{df}{cos θ 2} & ( 2 ) \\ [ expr . 3 ] & \\ df = df 1 - \frac{h}{tan θ 2} & ( 3 )\end{matrix}$$
in which “df1” is a distance between an intersection of a first imaginary line that extends in the horizontal direction through one of the light-blocking portions and a second imaginary line that is an extension of the sloping reflective member extended from the slope origin of the sloping reflective member toward a side away from the slope end and the light-output-side end of the light-blocking portions, “f1” is a distance between the slope end of the sloping reflective member and the intersection, and “h” is a space between the slope origin of the sloping reflective member and the light-output-side end of the light-blocking portions in the vertical direction.

4. The viewing angle control sheet according to claim 1, wherein the light-blocking portion is located away from the slope origin of the sloping reflective member in a horizontal direction and located away from the slope origin in a vertical direction on a side of the slope origin adjacent to the slope end of the sloping reflective member, and
df and f satisfy the following expressions (4) and (5),
$$\begin{matrix}[ expr . 4 ] & \\ f = f 2 - \frac{df \cdot tan θ 2 - k}{sin θ 2} + \frac{df}{cos θ 2} & ( 4 ) \\ [ expr . 5 ] & \\ df = df 2 + \frac{k}{tan θ 2} & ( 5 )\end{matrix}$$
in which “df2” is a distance between an intersection of a first imaginary line extending in the horizontal direction through one of the light-transmitting portions and the sloping reflective member and the light-output-side end of the light-blocking portions, “f2” is a distance between the slope end of the sloping reflective potion and the intersection, and “k” is a space between the slope origin of the sloping reflective member and the light-output-side end of the light-blocking portions in the vertical direction.

5. A method of producing a viewing angle control sheet, comprising:
a sheet formation process of forming a flat viewing angle control sheet including light-transmitting portions, which transmit light, and light-blocking portions, which block light, alternately arranged; and
a curving process of curving the flat viewing angle control sheet along a display surface of a display device located inwardly of a sloping reflective member that tilts forward and reflects light, the display surface curving in accordance with distance from the sloping reflective member, wherein
the flat viewing angle control sheet is curved in the curving process such that θ1 satisfies the following expression (6),
$$\begin{matrix}[ expr . 5 ] & \\ θ 1 ≦ {cos}^{- 1} ( \frac{f - df \cdot cos θ 2}{\sqrt{{f}^{2} + {df}^{2} - 2 \cdot f \cdot df \cdot cos θ 2}} ) + θ 2 & ( 6 )\end{matrix}$$
in which “f” is a length of the sloping reflective member, “df” is a distance between a slope origin of the sloping reflective member and a light-output-side end of the light-blocking portions, “θ1” is a maximum elevation angle of light passing through the light-transmitting portions, and “θ2” is an elevation angle of the sloping reflective member.

6. The method of producing the viewing angle control sheet according to claim 5, wherein the sheet formation process includes forming a continuous light-transmitting portion including the light-transmitting portions with spaces therebetween by a resin extrusion process and filling a light-blocking material into the spaces between the light-transmitting portions of the continuous light-transmitting portion adjacent to each other.
